(19) United States
(12) Patent Application Publication
(10) Pub. No.: US 2023/0060221 A1
(43) Pub. Date: Mar. 2, 2023

(54) LANE DEPARTURE SUPPRESSION DEVICE

(71) Applicant: TOYOTA JIDOSHA KABUSHIKI KAISHA, Toyota-shi (JP)

(72) Inventor: Masaaki HONDA, Okazaki-shi (JP)

(73) Assignee: TOYOTA JIDOSHA KABUSHIKI KAISHA, Toyota-shi (JP)

(21) Appl. No.: 17/875,869

(22) Filed: Jul. 28, 2022

(30) Foreign Application Priority Data
Sep. 1, 2021 (JP) 2021-142468

(51) Int. Cl. B62D 15/02

(52) U.S. Cl. CPC B62D 15/025; B62D 15/029

(57) ABSTRACT

When an automatic steering execution condition is satisfied, a lane departure suppression device executes automatic steering control that performs automatic steering by automatically applying a steering force to an own vehicle and positioning the own vehicle to a lane. The lane departure suppression device executes warning control that issues a warning to notify a driver of the own vehicle that the own vehicle may depart from the lane, when the lane departure suppression device determines that a warning execution condition is satisfied based on an actual traveling state of the own vehicle in a case where the automatic steering control is not being executed, and executes the warning control when the lane departure suppression device determines that the warning execution condition is satisfied based on a traveling state of the own vehicle achieved by the automatic steering control in a case where the automatic steering control is being executed.

### CROSS-REFERENCE TO RELATED APPLICATION

This application claims priority to Japanese Patent Application No. 2021-142468 filed on Sep. 1, 2021, incorporated herein by reference in its entirety.

### BACKGROUND

### 1. Technical Field

The present disclosure relates to a lane departure suppression device.

### 2. Description of Related Art

There are known lane departure suppression devices that perform, as lane departure suppression control to suppress an own vehicle from departing from a lane, warning control that issues a warning to notify the driver of the own vehicle when the own vehicle is about to depart from the lane, or automatic steering control that automatically applies steering force to the own vehicle to return the own vehicle to the lane.

### SUMMARY

As such lane departure suppression devices, there is known a lane departure suppression device that individually sets a determination value used to determine whether to start warning control and a determination value used to determine whether to start automatic steering control (see, for example, Japanese Unexamined Patent Application Publication No. 2005-242483 (JP 2005-242483 A)).

The warning control is control for prompting the driver to perform a driving operation (departure avoidance operation) to return the own vehicle that is about to depart from the lane to the lane, while the automatic steering control is control for automatically applying steering force to the own vehicle to return the own vehicle to the lane without prompting the driver to perform the departure avoidance operation. Since the purpose of these controls is different, there are certain benefits to individually setting the determination value used to determine whether to start the warning control and the determination value used to determine whether to start the automatic steering control.

However, when such determination values are set individually, for example, a warning may be issued after the automatic steering control is started. In such a case, the own vehicle is eventually returned to the lane by the automatic steering control, so that the driver may feel that an unnecessary warning has been issued. In other words, the driver may feel annoyed by the warning.

An object of the present disclosure is to provide a lane departure suppression device capable of reducing the possibility that the driver feels annoyed by a warning for notifying the driver that the own vehicle may depart from the lane.

A lane departure suppression device according to the present disclosure is provided with a control device that executes warning control and automatic steering control. The warning control is control that issues a warning to notify a driver of an own vehicle that there is a possibility that the own vehicle departs from a lane, and the automatic steering control is control that performs automatic steering by automatically applying a steering force to the own vehicle having the possibility to depart from the lane and by positioning the own vehicle to the lane.

In the lane departure suppression device according to the present disclosure, the control device is configured to execute the automatic steering control when an automatic steering execution condition is satisfied. Further, the control device is configured to execute the warning control when the control device determines that a warning execution condition is satisfied based on an actual traveling state of the own vehicle in a case where the automatic steering control is not being executed. On the other hand, the control device is configured to execute the warning control when the control device determines that the warning execution condition is satisfied based on a traveling state of the own vehicle achieved by the automatic steering control in a case where the automatic steering control is being executed.

When determining whether the own vehicle departs from the lane, if the future traveling state of the own vehicle can be predicted, whether the own vehicle departs from the lane can be determined more accurately by determining whether the own vehicle departs from the lane based on the future traveling state of the own vehicle, rather than determining whether the own vehicle departs from the lane based on the actual traveling state of the own vehicle (that is, the current traveling state of the own vehicle). When the automatic steering control is being executed, the braking force is automatically applied to the own vehicle, which makes it possible to predict the future traveling state of the own vehicle achieved by the automatic steering control.

According to the present disclosure, when the automatic steering control is being executed, it is determined whether the warning execution condition is satisfied based on the traveling state of the own vehicle achieved by the automatic steering control. Accordingly, it is possible to more accurately determine whether the own vehicle departs from the lane. The warning control is executed only when the own vehicle is likely to depart from the lane, and the warning control is not executed when the own vehicle is unlikely to depart from the lane. This makes it possible to reduce the possibility that the driver feels annoyed by the warning issued by the warning control.

In the lane departure suppression device according to the present disclosure, the control device may be configured to determine that the warning execution condition is satisfied when a position of the own vehicle after a predetermined time, the position being predicted based on the actual traveling state of the own vehicle, reaches a predetermined determination line in the case where the automatic steering control is not being executed. In this case, the control device may be configured to determine that the warning execution condition is satisfied when a position of the own vehicle after the predetermined time, the position being predicted based on the traveling state of the own vehicle achieved by the automatic steering control, reaches the determination line in the case where the automatic steering control is being executed.

According to the present disclosure, it is determined that the warning execution condition is satisfied when a position of the own vehicle after the predetermined time, the position being predicted based on the traveling state of the own vehicle achieved by the automatic steering control, reaches the determination line in the case where the automatic steering control is being executed. That is, it is determined whether the warning execution condition is satisfied based on the traveling state of the own vehicle achieved by the automatic steering control. Therefore, when the automatic steering control is being executed, it is possible to more accurately determine whether the own vehicle departs from the lane. The warning control is executed only when the own vehicle is likely to depart from the lane, and the warning control is not executed when the own vehicle is unlikely to depart from the lane. This makes it possible to reduce the possibility that the driver feels annoyed by the warning issued by the warning control.

In the lane departure suppression device according to the present disclosure, the control device may be configured to determine that the warning execution condition is satisfied when the own vehicle reaches a determination line set based on the actual traveling state of the own vehicle in the case where the automatic steering control is not being executed. In this case, the control device may be configured to determine that the warning execution condition is satisfied when the own vehicle reaches the determination line set based on the traveling state of the own vehicle achieved by the automatic steering control in the case where the automatic steering control is being executed.

According to the present disclosure, it is determined that the warning execution condition is satisfied when the own vehicle reaches the determination line set based on the traveling state of the own vehicle achieved by the automatic steering control in the case where the automatic steering control is being executed. That is, it is determined whether the warning execution condition is satisfied based on the traveling state of the own vehicle achieved by the automatic steering control. Therefore, when the automatic steering control is being executed, it is possible to more accurately determine whether the own vehicle departs from the lane. The warning control is executed only when the own vehicle is likely to depart from the lane, and the warning control is not executed when the own vehicle is unlikely to depart from the lane. This makes it possible to reduce the possibility that the driver feels annoyed by the warning issued by the warning control.

The components of the present disclosure are not limited to the embodiment of the present disclosure described later with reference to the drawings. Other objects, other features, and accompanying advantages of the present disclosure will be readily understood from the description of the embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a lane departure suppression device according to an embodiment of the present disclosure and a vehicle (an own vehicle) on which the device is mounted;

FIG. 2 is a diagram showing a scene in which the own vehicle is traveling in a direction departing from a lane;

FIG. 3 is a diagram showing a scene where a predicted vehicle position reaches a first predicted position determination line;

FIG. 4 is a diagram showing a scene in which a steering force is applied to the own vehicle by automatic steering control and the own vehicle returns to the lane;

FIG. 5 is a diagram showing a scene where the predicted vehicle position reaches a second predicted position determination line;

FIG. 6 is a diagram showing a road in which a guardrail is installed on the left side of the lane;

FIG. 7 is a flowchart showing a routine executed by the lane departure suppression device according to the embodiment of the present disclosure; and

FIG. 8 is a flowchart showing a routine executed by the lane departure suppression device according to the embodiment of the present disclosure.

### DETAILED DESCRIPTION OF EMBODIMENTS

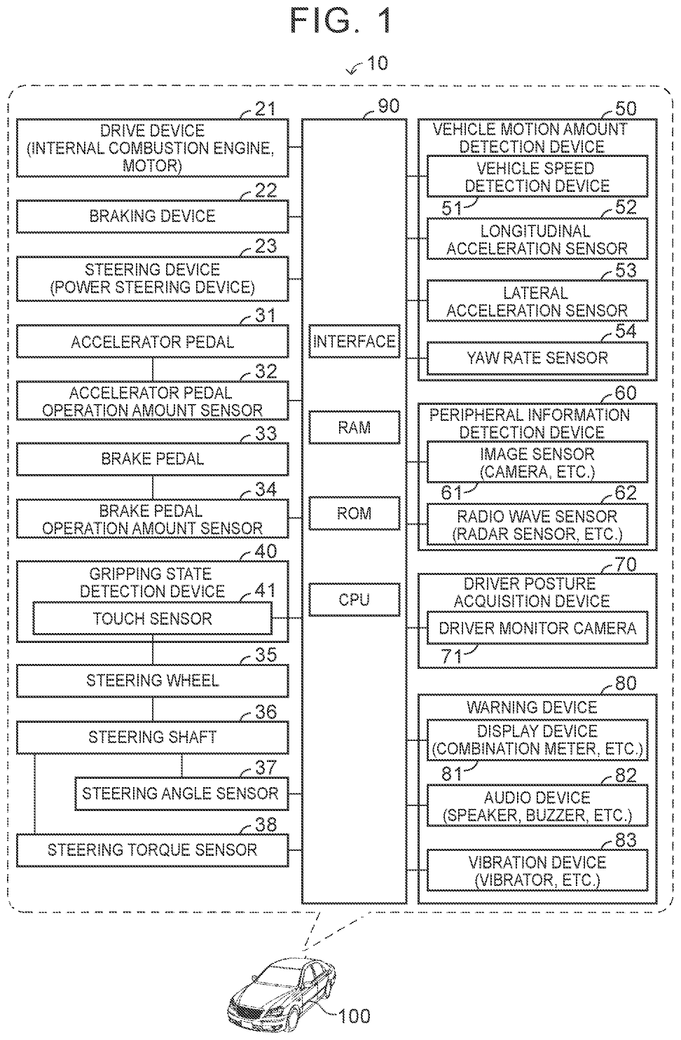

Hereinafter, a lane departure suppression device according to an embodiment of the present disclosure will be described with reference to the drawings. As shown in FIG. 1, a lane departure suppression device 10 according to the embodiment of the present disclosure is mounted on an own vehicle 100.

### ECU

The lane departure suppression device 10 includes an ECU 90 as a control device. The term ECU is an abbreviation for electronic control unit. The ECU 90 includes a microcomputer as a main part. The microcomputer includes a central processing unit (CPU), a read-only memory (ROM), a random access memory (RAM), a non-volatile memory, an interface, and the like. The CPU realizes various functions by executing instructions, programs, or routines stored in the ROM.

### Drive Device, Etc.

The own vehicle 100 is equipped with a drive device 21, a braking device 22, and a steering device 23.

### Drive Device

The drive device 21 is a device that outputs a driving torque (driving force) applied to the own vehicle 100 in order to cause the own vehicle 100 to travel, and is, for example, an internal combustion engine, a motor, or the like. The drive device 21 is electrically connected to the ECU 90. The ECU 90 can control the driving torque output from the drive device 21 by controlling the operation of the drive device 21.

### Braking Device

The braking device 22 is a device that outputs a braking torque (braking force) applied to the own vehicle 100 in order to brake the own vehicle 100. The braking device 22 is electrically connected to the ECU 90. The ECU 90 can control the braking torque output from the braking device 22 by controlling the operation of the braking device 22.

### Steering Device

The steering device 23 is a device that outputs a steering torque (steering force) applied to the own vehicle 100 in order to steer the own vehicle 100, and is, for example, a power steering device. The steering device 23 is electrically connected to the ECU 90. The ECU 90 can control the steering torque output from the steering device 23 by controlling the operation of the steering device 23.

### Sensors, Etc.

An accelerator pedal 31, an accelerator pedal operation amount sensor 32, a brake pedal 33, a brake pedal operation amount sensor 34, a steering wheel 35, a steering shaft 36, a steering angle sensor 37, a steering torque sensor 38, a gripping state detection device 40, a vehicle motion amount detection device 50, a peripheral information detection device 60, a driver posture acquisition device 70, and a warning device 80 are also mounted on the own vehicle 100.

### Accelerator Pedal Operation Amount Sensor

The accelerator pedal operation amount sensor 32 is a sensor that detects the operation amount of the accelerator pedal 31. The accelerator pedal operation amount sensor 32 is electrically connected to the ECU 90. The accelerator pedal operation amount sensor 32 transmits the detected operation amount information of the accelerator pedal 31 to the

ECU 90. The ECU 90 acquires the operation amount of the accelerator pedal 31 as the accelerator pedal operation amount AP based on the information.

The ECU 90 acquires a required driving torque (required driving force) by calculation based on the accelerator pedal operation amount AP and the traveling speed (vehicle speed SPD) of the own vehicle 100. The required driving torque is the driving torque required to be output from the drive device 21. The ECU 90 controls the operation of the drive device 21 so that the required driving torque is output.

Brake Pedal Operation Amount Sensor

The brake pedal operation amount sensor 34 is a sensor that detects the operation amount of the brake pedal 33. The brake pedal operation amount sensor 34 is electrically connected to the ECU 90. The brake pedal operation amount sensor 34 transmits the detected operation amount information of the brake pedal 33 to the ECU 90. The ECU 90 acquires the operation amount of the brake pedal 33 as the brake pedal operation amount BP based on the information.

The ECU 90 acquires the required braking torque (required braking force) by calculation based on the brake pedal operation amount BP. The required braking torque is the braking torque required to be output from the braking device 22. The ECU 90 controls the operation of the braking device 22 so that the required braking torque is output.

### Steering Angle Sensor

The steering angle sensor 37 is a sensor that detects the rotation angle of the steering shaft 36 with respect to the neutral position. The steering angle sensor 37 is electrically connected to the ECU 90. The steering angle sensor 37 transmits the detected rotation angle information of the steering shaft 36 to the ECU 90. The ECU 90 acquires the rotation angle of the steering shaft 36 as the steering angle 0 based on the information.

### Steering Torque Sensor

The steering torque sensor 38 is a sensor that detects the torque input to the steering shaft 36 by a driver DR of the own vehicle 100 via the steering wheel 35. The steering torque sensor 38 is electrically connected to the ECU 90. The steering torque sensor 38 transmits the detected torque information to the ECU 90. The ECU 90 acquires the torque (driver input torque) input to the steering shaft 36 by the driver DR via the steering wheel 35 based on the information.

### Gripping State Detection Device

The gripping state detection device 40 is a device that detects the gripping state of the steering wheel 35 by the driver DR, and in this example, is a touch sensor 41 installed on the steering wheel 35.

### Touch Sensor

The touch sensor 41 is a sensor that detects that the driver DR has touched the steering wheel 35. The touch sensor 41 is electrically connected to the ECU 90. When the touch sensor 41 detects that the driver DR has touched the steering wheel 35, the touch sensor 41 transmits information (a signal) relating to the portion of the steering wheel 35 touched by the driver DR to the ECU 90. The ECU 90 recognizes the portion of the steering wheel 35 touched by the driver DR based on the information (signal), and the ECU 90 can thus determine whether the driver DR is in a state capable of performing a driving operation on the own vehicle 100 based on the recognized portion of the steering wheel 35. The state in which the driver DR can perform a driving operation on the own vehicle 100 is, for example, a state in which the driver DR grips the portion of the steering wheel 35 appropriate for the driving operation with both hands.

### Vehicle Motion Amount Detection Device

The vehicle motion amount detection device 50 is a device that detects the motion amount of the own vehicle 100, and in this example, includes a vehicle speed detection device 51, a longitudinal acceleration sensor 52, a lateral acceleration sensor 53, and a yaw rate sensor 54.

### Vehicle Speed Detection Device

The vehicle speed detection device 51 is a device that detects the traveling speed (vehicle speed) of the own vehicle 100, and is, for example, a wheel speed sensor. The vehicle speed detection device 51 is electrically connected to the ECU 90. The vehicle speed detection device 51 transmits the detected vehicle speed information of the own vehicle 100 to the ECU 90. The ECU 90 acquires the vehicle speed SPD of the own vehicle 100 based on the information.

The ECU 90 acquires the required steering torque by calculation based on the acquired steering angle θ, the driver input torque, and the vehicle speed SPD. The required steering torque is the steering torque required to be output from the steering device 23. The ECU 90 controls the operation of the steering device 23 so that the required steering torque is output from the steering device 23, except when the automatic steering control described later is executed.

### Longitudinal Acceleration Sensor

The longitudinal acceleration sensor 52 is a sensor that detects the acceleration of the own vehicle 100 in the front-rear direction. The longitudinal acceleration sensor 52 is electrically connected to the ECU 90. The longitudinal acceleration sensor 52 transmits the detected acceleration information to the ECU 90. The ECU 90 acquires the acceleration in the front-rear direction of the own vehicle 100 as the longitudinal acceleration GX based on the information.

### Lateral Acceleration Sensor

The lateral acceleration sensor 53 is a sensor that detects the acceleration of the own vehicle 100 in the lateral direction (width direction). The lateral acceleration sensor 53 is electrically connected to the ECU 90. The lateral acceleration sensor 53 transmits the detected acceleration information to the ECU 90. The ECU 90 acquires the acceleration in the lateral direction of the own vehicle 100 as the lateral acceleration GY based on the information.

### Yaw Rate Sensor

The yaw rate sensor 54 is a sensor that detects the yaw rate YR of the own vehicle 100. The yaw rate sensor 54 is electrically connected to the ECU 90. The yaw rate sensor 54 transmits the detected information of the yaw rate YR to the ECU 90. The ECU 90 acquires the yaw rate YR of the own vehicle 100 based on the information. For example, the yaw rate YR is used for determining the steering force to be applied to the own vehicle 100 when the own vehicle 100 is automatically turned by automatically applying the steering force to the own vehicle 100 by the automatic steering control described later.

### Peripheral Information Detection Device

The peripheral information detection device 60 is a device that detects information of the periphery of the own vehicle 100, and in this example, includes an image sensor 61 and a radio wave sensor 62. The image sensor 61 is, for example, a camera. The radio wave sensor 62 is, for example, a radar sensor (millimeter wave radar or the like). The peripheral information detection device 60 may include a sound wave sensor such as an ultrasonic sensor (clearance sonar) or an optical sensor such as a laser radar (LiDAR).

### Image Sensor

The image sensor 61 is electrically connected to the ECU 90. The image sensor 61 captures an image of the periphery of the own vehicle 100 and transmits information related to the captured image to the ECU 90. The ECU 90 can acquire information (peripheral detection information INF D) about the periphery of the own vehicle 100 based on the information (image information).

### Radio Wave Sensor

The radio wave sensor 62 is electrically connected to the ECU 90. The radio wave sensor 62 transmits radio waves and receives radio waves (reflected waves) reflected by an object. The radio wave sensor 62 transmits information (detection result) related to the transmitted radio waves and the received radio waves (reflected waves) to the ECU 90. In other words, the radio wave sensor 62 detects an object existing in the periphery of the own vehicle 100, and transmits information (detection result) related to the detected object to the ECU 90. The ECU 90 can acquire information (peripheral detection information INF D) related to the object existing in the periphery of the own vehicle 100 based on the information (radio wave information).

### Driver Posture Acquisition Device

The driver posture acquisition device 70 is a device that detects the consciousness state of the driver DR, and in this example, it is a driver monitor camera 71. The driver monitor camera 71 is provided in the vehicle cabin of the own vehicle 100 toward the driver DR so that the face of the driver DR can be imaged.

### Driver Monitor Camera

The driver monitor camera 71 is a camera that captures the face of the driver DR. The driver monitor camera 71 is electrically connected to the ECU 90. The driver monitor camera 71 transmits information (image data) related to the captured image of the face of the driver DR to the ECU 90. The ECU 90 can determine whether the driver DR is in a state capable of performing a driving operation on the own vehicle 100 based on the information. The state in which the driver DR can perform a driving operation on the own vehicle 100 is, for example, a state in which the driver DR faces the steering wheel 35 and the eyes of the driver DR are open (that is, the driver DR is awake).

### Warning Device

The warning device 80 is a device for notifying the driver DR that the own vehicle 100 may depart from the lane LN, and in this example, includes a display device 81, an audio device 82, and a vibration device 83.

### Display Device

The display device 81 is a device for displaying an image, and is, for example, a human machine interface (HMI) such as a combination meter or a head-up display (HUD). The display device 81 is electrically connected to the ECU 90. The ECU 90 can display various images on the display device 81.

### Audio Device

The audio device 82 is a device that outputs a voice such as an announcement or an electronic sound such as a buzzer sound, and is, for example, a speaker or a buzzer. The audio device 82 is electrically connected to the ECU 90. The ECU 90 can output various voices or various electronic sounds from the audio device 82.

### Vibration Device

The vibration device 83 is a device that gives vibration to the driver DR, and is, for example, a vibrator built in the steering wheel 35 or the driver's seat. The vibration device 83 is electrically connected to the ECU 90. The ECU 90 can give vibration to the driver DR by operating the vibration device 83.

### Outline of Operation of Lane Departure Suppression Device

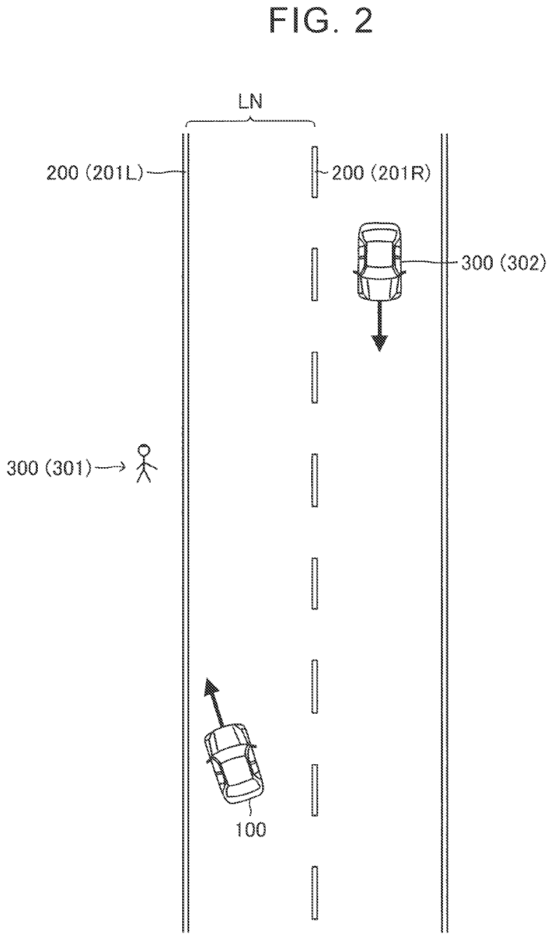

Next, the outline of the operation of the lane departure suppression device 10 will be described. For example, as shown in FIG. 2, if the driver DR does not perform an appropriate driving operation after the own vehicle 100 starts to travel toward the definition line 201 on the left side (left definition line 201L), the own vehicle 100 will depart from the lane LN.

Therefore, when the lane departure suppression device 10 determines that the own vehicle 100 may depart from the lane LN, the lane departure suppression device 10 executes lane departure suppression control for suppressing the own vehicle 100 from departing from the lane LN. In this example, the lane departure suppression control includes automatic steering control and warning control.

The automatic steering control is control that automatically applies a steering force to the own vehicle 100 that is about to depart from the lane LN to return the own vehicle 100 to the lane LN. The warning control is control that issues a warning to notify the driver DR that the own vehicle 100 may depart from the lane LN. Hereinafter, the automatic steering control and the warning control will be described.

In this example, the warning issued by the warning control is performed by at least one of display on the display device 81 of an image and/or lighting on the display device 81 of the lamp indicating that the own vehicle 100 may depart from the lane LN, output of voice from the audio device 82 and/or output of a buzzer sound from the audio device 82 indicating that the own vehicle 100 may depart from the lane LN, and vibration of the steering wheel 35 and/or the driver's seat by the vibration device 83.

### Automatic Steering Control

The lane departure suppression device 10 executes the automatic steering control when the automatic steering execution condition C_LDP is satisfied. In this example, the automatic steering execution condition C_LDP is satisfied when the automatic steering permission condition C_AS is satisfied and the lane departure condition (first departure condition C_D1) is satisfied.

The automatic steering permission condition C_AS is a condition for determining whether the requirement necessary for executing the automatic steering control in an appropriate manner is satisfied. In this example, the automatic steering permission condition C_AS is satisfied when the lane departure suppression device 10 can detect a lane definition object 200, the current vehicle speed SPD_N (current vehicle speed SPD of the own vehicle 100) is a vehicle speed within the predetermined vehicle speed range R_TH, and the driver DR is not performing an override operation.

The lane definition object 200 defines the lane LN, and in this example, is the definition line 201 on the left side of the lane LN (left definition line 201L), a definition line 201 on the right side of the lane LN (right definition line 201R), a road end such as grass and soil on the left side of the lane LN (left road end), a road end such as grass and soil on the right side of the lane LN (right road end), a guardrail on the left side of the lane LN (left guardrail), and a guardrail on the right side of the lane LN (right guardrail).

The lane departure suppression device 10 can detect the left definition line 201L, the right definition line 201R, the left road end, the right road end, the left guardrail, and the right guardrail based on the peripheral detection information INF_D.

Further, the override operation is, for example, an operation on the steering wheel 35 for avoiding the departure of the own vehicle 100 from the lane LN (the lane departure of the own vehicle 100).

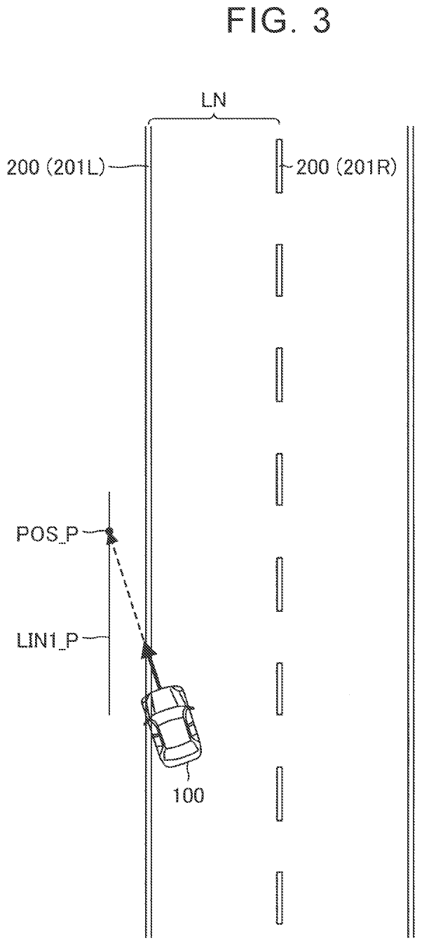

The first departure condition C_D1 is satisfied when the position of the own vehicle 100 after a predetermined time T (predicted vehicle position POS_P) reaches the first predicted position determination line LIN1_P, as shown in FIG. 3. In this example, the predetermined time T is a time predetermined as an appropriate time for determining the start timing of the lane departure suppression control.

The first predicted position determination line LIN1_P is a line extending along the lane definition object 200 (the left definition line 201L in the example shown in FIG. 3). The lane departure suppression device 10 sets the first predicted position determination line LIN1_P so that in the case where the automatic steering control is started when the predicted vehicle position POS_P reaches the first predicted position determination line LIN1_P, the automatic steering control can avoid the lane departure of the own vehicle 100 while ensuring the traveling safety of the own vehicle 100.

When setting the first predicted position determination line LIN1_P, the lane departure suppression device 10 takes into consideration factors such as the distance (definition object distance DIS 200) between the lane definition object 200 and the current position of the own vehicle 100 (current vehicle position POS_N), the current vehicle speed SPD (current vehicle speed SPD_N), the steering performance of the steering device 23, the allowable lateral acceleration of the own vehicle 100, and the type of the lane definition object 200 (whether the lane definition object 200 is a flat object such as the definition line 201 or the road end, or whether the lane definition object 200 is a three-dimensional structure such as the guardrail).

Further, the lane departure suppression device 10 acquires the predicted vehicle position POS_P based on the current vehicle position POS_N (current position of the own vehicle 100), the current vehicle speed SPD_N (current vehicle speed SPD), the current lateral acceleration GYN (current lateral acceleration GY of the own vehicle 100), and the predetermined time T. Specifically, the lane departure suppression device 10 acquires the predicted vehicle position POS_P by calculation according to the following equation 1 based on the current vehicle position POS_N, the current vehicle speed SPD_N, the current lateral acceleration GY_N, and the predetermined time T.

POS_P=_POS_N+SPD_N×T+1/2×GY_N×T2 (1)

In this example, the lane departure suppression device 10 acquires the current vehicle position POS_N with reference to the position of the lane definition object 200 based on the peripheral detection information INF_D.

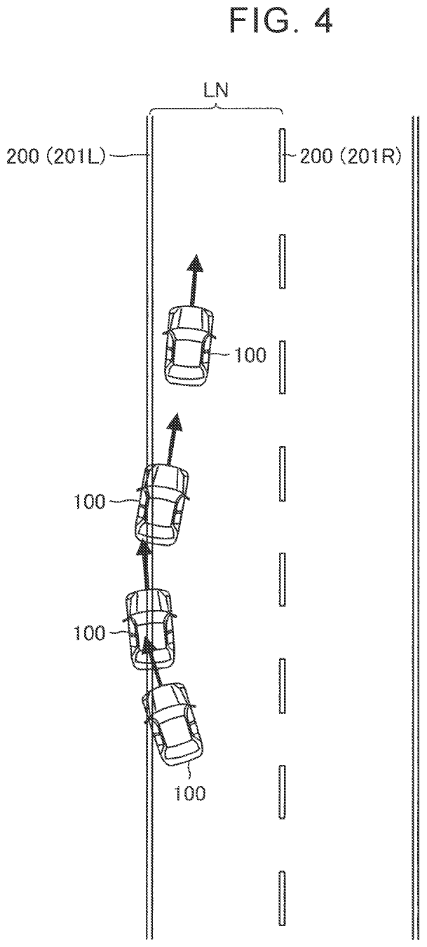

When the automatic steering control is started, the lane departure suppression device 10 controls the operation of the steering device 23 and applies a steering force to the own vehicle 100 so that the own vehicle 100 returns to the lane LN. Accordingly, as shown in FIG. 4, the own vehicle 100 is returned to the lane LN.

As described above, the lane departure suppression device 10 determines whether the first departure condition C_D1 is satisfied based on whether the predicted vehicle position POS_P has reached the first predicted position determination line LIN1_P. However, a determination line (first current position determination line LIN1_N) different from the first predicted position determination line LIN1_P may be set, and the lane departure suppression device 10 may be configured to determine whether the first departure condition C_D1 is satisfied based on whether the current vehicle position POS_N has reached the first current position determination line LIN1_N.

In this case, the lane departure suppression device 10 sets, for example, the first predicted position determination line LIN1_P as described above, and in parallel with this, acquires the distance at which the own vehicle 100 moves in the lateral direction (predicted lateral movement distance DIS_P) from the present time until the predetermined time T elapses, and sets the line acquired by moving the first predicted position determination line LIN1_P closer to the lane LN by the predicted lateral movement distance DIS_P as the first current position determination line LIN1_N.

The lane departure suppression device 10 acquires the predicted lateral movement distance DIS_P by calculation according to the following equation 2 based on the current vehicle speed SPD_N, the current lateral acceleration GY_N, and the predetermined time T.

DIS_P=SPD_N×T+1/2×GYN×T2 (2)

### Warning Control

The lane departure suppression device 10 executes the warning control when the warning execution condition C_LDA is satisfied.

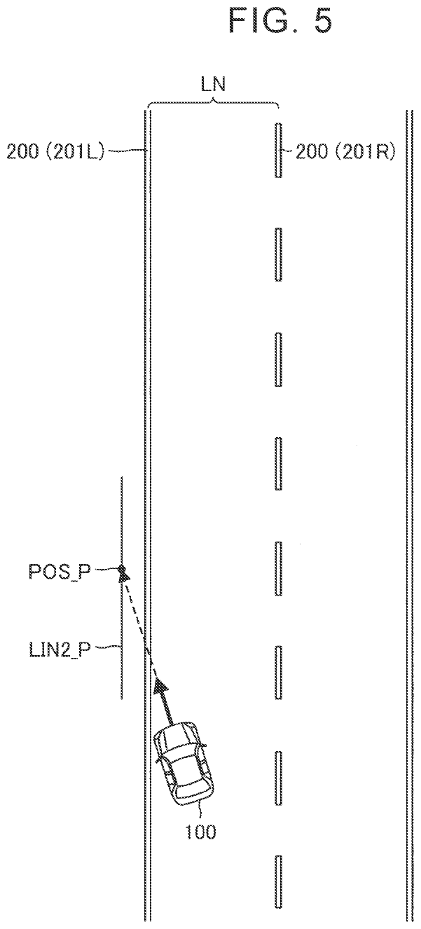

Here, the warning execution condition C_LDA is satisfied when the lane departure condition (second departure condition C_D2) is satisfied. The second departure condition C_D2 is satisfied when the predicted vehicle position POS_P has reached the second predicted position determination line LIN2_P, as shown in FIG. 5.

The second predicted position determination line LIN2_P is a line extending along the lane definition object 200 (the left definition line 201L in the example shown in FIG. 5), and is a line that allows the driver DR to notice the warning issued by the warning control and thus allows the driver DR to sufficiently avoid the lane departure of the own vehicle 100 by operation of the steering wheel 35, in the case where the warning control is started when the predicted vehicle position POS_P has reached the second predicted position determination line LIN2_P.

Therefore, the lane departure suppression device 10 sets the second predicted position determination line LIN2 _P so that in the case where the warning control is started when the predicted vehicle position POS_P has reached the second predicted position determination line LIN2_P, the lane departure of the own vehicle 100 can be avoided by the departure avoidance operation of the driver DR (driving operation for avoiding the departure of the own vehicle 100 from the lane LN) while ensuring the traveling safety of the own vehicle 100.

When setting the second predicted position determination line LIN2_P, the lane departure suppression device 10 takes into consideration factors such as the definition object distance DIS 200 (distance between the lane definition object 200 and the current vehicle position POS_N), the current vehicle speed SPD_N, the driving operation ability of the driver DR (especially the steering wheel operation ability of the driver DR), and the type of the lane definition object 200 (whether the lane definition object 200 is a flat object such as the definition line 201 or a road end, or whether the lane definition object 200 is a three-dimensional structure such as a guardrail).

When the automatic steering control is not being executed, the lane departure suppression device 10 determines whether the warning execution condition C_LDA is satisfied based on the actual traveling state of the own vehicle 100. More specifically, the lane departure suppression device 10 acquires the predicted vehicle position POS_P based on the actual traveling state of the own vehicle 100. More specifically, as described above, the lane departure suppression device 10 acquires the predicted vehicle position POS_P based on the current vehicle position POS_N, the current vehicle speed SPD_N, the current lateral acceleration GY_N, and the predetermined time T. Specifically, the lane departure suppression device 10 acquires the predicted vehicle position POS_P by calculation according to the above equation 1 based on the current vehicle position POS_N, the current vehicle speed SPD_N, the current lateral acceleration GY_N, and the predetermined time T.

On the other hand, when the automatic steering control is being executed, the lane departure suppression device 10 determines whether the warning execution condition C_LDA is satisfied based on the traveling state of the own vehicle 100 achieved by the automatic steering control. More specifically, the lane departure suppression device 10 acquires the predicted vehicle position POS_P based on the traveling state of the own vehicle 100 achieved by the automatic steering control. More specifically, the lane departure suppression device 10 acquires the predicted vehicle position POS_P based on the current vehicle position POS_N (current position of the own vehicle 100), the current vehicle speed

SPD_N (current vehicle speed SPD), the predicted lateral acceleration GYP (lateral acceleration GY of the own vehicle 100 achieved by the automatic steering control), and the predetermined time T. Specifically, the lane departure suppression device 10 acquires the predicted vehicle position POS_P by calculation according to the following equation 3 based on the current vehicle position POS_N, the current vehicle speed SPD_N, the predicted lateral acceleration GY_P, and the predetermined time T.

POS_P=POS_N+SPD_N×T+1/2×GYP×T2 (3)

In this example, the departure avoidable condition C_DP is satisfied when the automatic steering permission condition C_AS is satisfied.

As described above, the lane departure suppression device 10 determines whether the second departure condition C_D2 is satisfied based on whether the predicted vehicle position POS_P has reached the second predicted position determination line LIN2_P. However, a determination line (second current position determination line LIN2_N) different from the second predicted position determination line LIN2_P may be set, and the lane departure suppression device 10 may be configured to determine whether the second departure condition C_D2 is satisfied based on whether the current vehicle position POS_N has reached the second current position determination line LIN2_N.

In this case, the lane departure suppression device 10 sets, for example, the second predicted position determination line LIN2_P as described above, and in parallel with this, acquires the predicted lateral movement distance DIS_P, and sets the line acquired by moving the second predicted position determination line LIN2_P closer to the lane LN by the predicted lateral movement distance DIS_P as the second current position determination line LIN2_N.

In this case, when the automatic steering control is not being executed, the lane departure suppression device 10 acquires the predicted lateral movement distance DIS_P by calculation according to the above equation 2 based on the current vehicle speed SPD_N, the current lateral acceleration GY_N, and the predetermined time T.

On the other hand, when the automatic steering control is being executed, the lane departure suppression device 10 acquires the predicted lateral movement distance DIS_P by calculation according to the following equation 4 based on the current vehicle speed SPD_N, the predicted lateral acceleration GY_P, and the predetermined time T.

DIS_P=SPD_N×T+1/2×GYP×T2 (4)

### Effects

The lane departure suppression device 10 sets the first predicted position determination line LIN1_P and the second predicted position determination line LIN2_P in consideration of different factors. Thus, the predicted vehicle position POS_P may reach the first predicted position determination line LIN1_P first, or may reach the second predicted position determination line LIN2_P first. Accordingly, when the predicted vehicle position POS_P reaches the second predicted position determination line LIN2_P, the predicted vehicle position POS_P may have reached or may have not reached the first predicted position determination line LIN1_P. That is, when the predicted vehicle position POS_P reaches the second predicted position determination line LIN2_P, the automatic steering control may or may not be executed.

Generally, when the automatic steering control is being executed, the lateral acceleration GY changes due to the steering force applied to the own vehicle 100 by the automatic steering control. Thus, when acquiring the position of the own vehicle 100 after the predetermined time T (predicted vehicle position POS_P), it is possible to more accurately acquire the predicted vehicle position POS_P by acquiring the predicted vehicle position POS_P using the lateral acceleration GY achieved by the automatic steering control, rather than acquiring the predicted vehicle position POS_P using the lateral acceleration GY at that time (current lateral acceleration GY_N). Therefore, when the automatic steering control is being executed, it is possible to reduce the possibility that the driver DR feels annoyed by the warning issued by the warning control by acquiring the predicted vehicle position POS_P using the lateral acceleration GY achieved by the automatic steering control, rather than acquiring the predicted vehicle position POS_P using the lateral acceleration GY at that time (current lateral acceleration GY_N).

When the automatic steering control is not being executed, the lane departure suppression device 10 acquires the predicted vehicle position POS_P using the current lateral acceleration GY_N, but when the automatic steering control is being executed, the lane departure suppression device 10 acquires the predicted vehicle position POS_P using the predicted lateral acceleration GY_P. This can reduce the possibility that the driver DR feels annoyed by the warning issued by the warning control.

The lane departure suppression device 10 may be configured to consider whether the driver DR is in a state capable of performing a driving operation on the own vehicle 100 when setting the second predicted position determination line LIN2_P. More specifically, the lane departure suppression device 10 may be configured to set the second predicted position determination line LIN2_P at a position farther from the lane LN when the driver DR is in a state capable of performing a driving operation on the own vehicle 100 than when the driver DR is not in a state capable of performing a driving operation on the own vehicle 100. Here, the fact that the driver DR is in a state capable of performing a driving operation on the own vehicle 100 is a state in which the driver DR grips the portion of the steering wheel 35 appropriate for the driving operation with both hands, the driver DR faces the steering wheel 35, and the eyes of the driver DR are open (that is, the driver DR is awake).

Further, the lane departure suppression device 10 may be configured to consider whether the lane definition object 200 is a three-dimensional structure 202 when setting the second predicted position determination line LIN2_P. More specifically, the lane departure suppression device 10 may set the second predicted position determination line

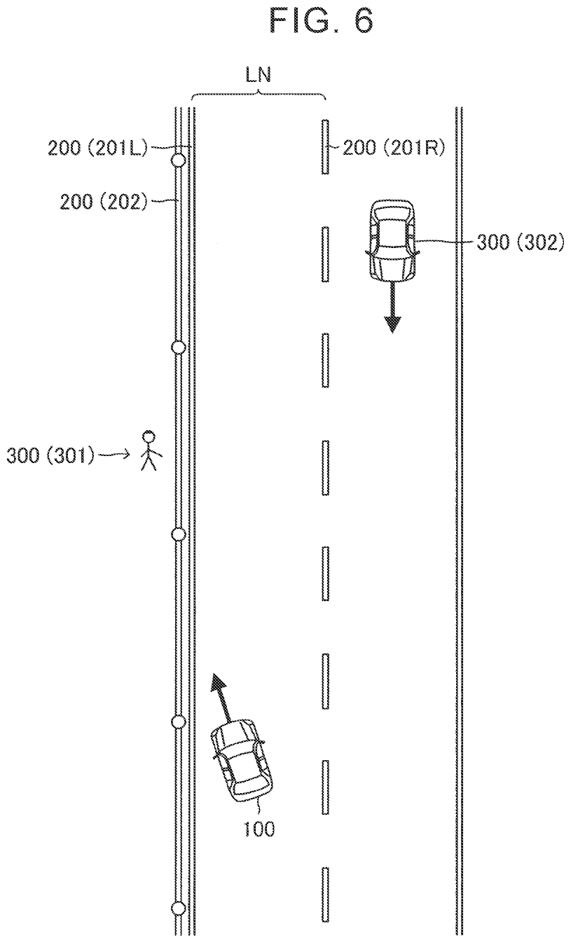

LIN2_P at a position closer to the lane LN when the lane definition object 200 is the three-dimensional structure 202 than when the lane definition object 200 is not the three-dimensional structure 202. Here, the three-dimensional structure 202 is, for example, a guardrail as shown in FIG. 6. The lane departure suppression device 10 can detect the three-dimensional structure 202 based on the peripheral detection information INF_D.

Further, the lane departure suppression device 10 may be configured to consider whether there is an object 300 outside the lane definition object 200 with which the own vehicle 100 may come into contact when setting the second predicted position determination line LIN2_P. More specifically, the lane departure suppression device 10 may set the second predicted position determination line LIN2_P at a position closer to the lane LN when there is the object 300 outside the lane definition object 200 with which the own vehicle 100 may come into contact than when there is no object 300 outside the lane definition object 200 with which the own vehicle 100 may come into contact. Here, the object 300 is a pedestrian 301, another vehicle 302, or the like, as shown in FIG. 2. The lane departure suppression device 10 can detect the object 300 based on the peripheral detection information INF D. When the object 300 is detected, and for example, when the object 300 is within a predetermined range ahead of the own vehicle 100 in the traveling direction, the lane departure suppression device 10 determines that there is the object 300 outside the lane definition object 200 with which the own vehicle 100 may come into contact.

### Specific Operation of Lane Departure Suppression Device

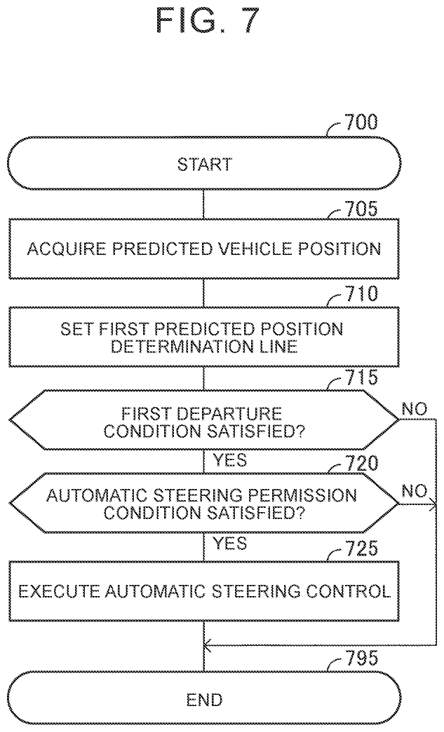

Next, the specific operation of the lane departure suppression device 10 will be described. The CPU of the ECU 90 of the lane departure suppression device 10 executes the routine shown in FIG. 7 at a predetermined calculation cycle. Therefore, at a predetermined timing, the CPU starts the process from step 700 of the routine shown in FIG.

7, and advances the process to step 705 to acquire the predicted vehicle position POS_P. Next, the CPU advances the process to step 710 to set the first predicted position determination line LIN1_P. Subsequently, the CPU advances the process to step 715 to determine whether the first departure condition C_D1 is satisfied.

When the CPU determines “Yes” in step 715, the CPU advances the process to step 720 to determine whether the automatic steering permission condition C_AS is satisfied.

When the CPU determines “Yes” in step 720, the CPU advances the process to step 725 to execute the automatic steering control. Next, the CPU advances the process to step 795 to temporarily end this routine.

On the other hand, when the CPU determines “No” in step 715 or step 720, the CPU directly advances the process to step 795 to temporarily end this routine.

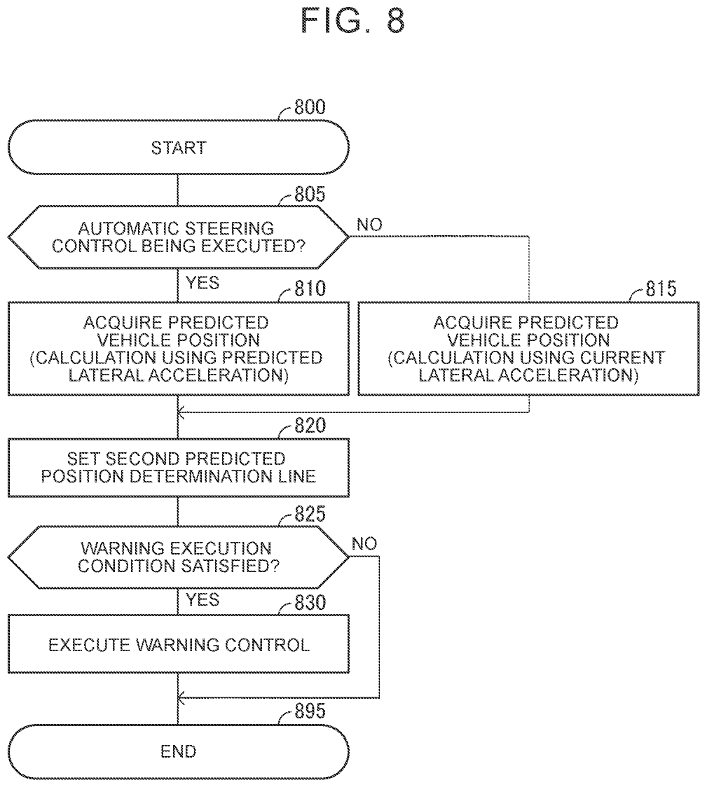

The CPU further executes the routine shown in FIG. 8 at a predetermined calculation cycle. Thus, at a predetermined timing, the CPU starts the process from step 800 of the routine shown in FIG. 8, and advances the process to step 805 to determine whether the automatic steering control is being executed.

When the CPU determines “Yes” in step 805, the CPU advances the process to step 810 to acquire the predicted vehicle position POS_P by the calculation according to the above equation 3 (calculation using the predicted lateral acceleration GY_P). The CPU then advances the process to step 820.

On the other hand, when the CPU determines “No” in step 805, the CPU advances the process to step 815 to acquire the predicted vehicle position POS_P by the calculation according to the above equation 1 (calculation using the current lateral acceleration GY_N). The CPU then advances the process to step 820.

When the CPU advances the process to step 820, the CPU sets the second predicted position determination line LIN2_P. Next, the CPU advances the process to step 825 to determine whether the warning execution condition C_LDA is satisfied.

When the CPU determines “Yes” in step 825, the CPU advances the process to step 830 to execute the warning control. Next, the CPU advances the process to step 895 to temporarily end this routine.

On the other hand, when the CPU determines “No” in step 825, the CPU directly advances the process to step 895 to temporarily end this routine. In this case, warning control is not executed.

This concludes the description of the specific operation of the lane departure suppression device 10.

The present disclosure is not limited to the above embodiment, and various modifications can be adopted within the scope of the present disclosure.

What is claimed is:

1. A lane departure suppression device comprising a control device that executes warning control and automatic steering control, the warning control being control that issues a warning to notify a driver of an own vehicle that there is a possibility that the own vehicle departs from a lane, and the automatic steering control being control that performs automatic steering by automatically applying a steering force to the own vehicle having the possibility to depart from the lane and by positioning the own vehicle to the lane, wherein the control device is configured to
execute the automatic steering control when an automatic steering execution condition is satisfied,
execute the warning control when the control device determines that a warning execution condition is satisfied based on an actual traveling state of the own vehicle in a case where the automatic steering control is not being executed, and
execute the warning control when the control device determines that the warning execution condition is satisfied based on a traveling state of the own vehicle achieved by the automatic steering control in a case where the automatic steering control is being executed.

2. The lane departure suppression device according to claim 1, wherein the control device is configured to
determine that the warning execution condition is satisfied when a position of the own vehicle after a predetermined time, the position being predicted based on the actual traveling state of the own vehicle, reaches a predetermined determination line in the case where the automatic steering control is not being executed, and
determine that the warning execution condition is satisfied when a position of the own vehicle after the predetermined time, the position being predicted based on the traveling state of the own vehicle achieved by the automatic steering control, reaches the determination line in the case where the automatic steering control is being executed.

3. The lane departure suppression device according to claim 1, wherein the control device is configured to
determine that the warning execution condition is satisfied when the own vehicle reaches a determination line set based on the actual traveling state of the own vehicle in the case where the automatic steering control is not being executed, and
determine that the warning execution condition is satisfied when the own vehicle reaches the determination line set based on the traveling state of the own vehicle achieved by the automatic steering control in the case where the automatic steering control is being executed.
